(19) United States
(12) Patent Application Publication
(10) Pub. No.: US 2013/0133587 A1
(43) Pub. Date: May 30, 2013

(54) Pet Grooming and Pest Terminating Comb

(71) Applicant: Carole Pelfrey, Point Pleasant, WV (US)

(72) Inventor: Carole Pelfrey, Point Pleasant, WV (US)

(21) Appl. No.: 13/688,277

(22) Filed: Nov. 29, 2012

Related U.S. Application Data
(60) Provisional application No. 61/565,274, filed on Nov. 30, 2011.

(51) Int. Cl. A01K 13/00

(52) U.S. Cl. CPC A01K 13/00
USPC 119/625

(57) ABSTRACT

Disclosed is a pet grooming and pest killing device that comprises a handled comb having a working end comprising a plurality of comb tooth electrodes powered by a battery power supply within the handle of the device. The comb teeth employ an alternating configuration wherein adjacent teeth employ opposing polarity and the tips of the teeth are shrouded by a protective insulator. The spacing of the teeth is such that a tick or flea will become trapped between two teeth, allowing current to flow from one electrode to another through the pest and thus killing it upon contact. The ends of the teeth are insulated to prevent shocking of the pet during the combing process. In this way, pet hair can be tended to while also killing loose ticks, fleas and other pests within the pet's hair while grooming.

### CROSS REFERENCE TO RELATED APPLICATION

This application claims the benefit of U.S. Provisional Application No. 61/565,274 filed on Nov. 30, 2011, entitled “Pet Flea and Tick Remover.” The above identified patent application is herein incorporated by reference in its entirety to provide continuity of disclosure.

### BACKGROUND OF THE INVENTION

1. Field of the Invention

The present invention relates to pet combs and pest removal devices. More specifically, the present invention relates to an electrified comb that is adapted to remove loose hair and debris from a pet, as well as electrically shock and kill any pests within the pet's hair to prevent imbedding into the pet skin if not adequately removed.

Pet grooming is an essential activity for an animal and a pet owner, and in particular the act of removing shedding hair, undercoats and other loose hair from the pet provides a means to maintain the pet's appearance, cleanliness around a household and overall health. Brushing and combing a pet is a hygienic activity that improves the luster, shine and health of the pet's coat, while reducing loose hair that quickly spreads about a house. Common implements for removing pet hair and dander include brushes, combs, blades and other assorted handheld implements. These devices remove loose hair, massage the pet and stimulate the pet's skin.

Along with overall hygiene and appearance, an associated activity to removing loose hair is the removal of ticks, lice and other pests that commonly cling to a pet's hair, particularly for those pets who frequently roam outdoors and in natural environments. Ticks and other insects can quickly navigate through the pet's outer coat of hair and imbed themselves into the skin surface of their host, which makes them difficult to remove and a risk for the pet's health. Finding and removing these pests from a pet's hair is difficult, and ensuring complete removal is a further difficulty using traditional combs and brushes. While tweezer devices have been developed to remove these pests once imbedded into the pet's skin, it is desired to provide a means to comb through the pet's hair and eradicate these pests prior to their contact with the pet's skin surface. This can provide a prophylactic measure after periods of outdoor activity, in while the owner of the pet is capable of quickly killing loose ticks, lice and other pests within the dog's hair while also removing outdoor debris and loose hair. Removing the pests prior to their attaching to their host prevents irritation to the pet and further aggravation for the owner when locating individual tick sites and attempting removal thereof.

The present invention pertains to a new and improved pet grooming device that also acts as a means to kill and remove ticks, fleas and other insect pests from a pet's hair. Prior to the pest borrowing into the host pet's skin, the comb is utilized as a means to electrocute and kill the pest during the grooming activity. This ensures the pest will not escape the comb and venture further towards to host pet's body. The device itself is a handheld, battery powered comb device having a novel comb working end that forms a network of electrodes that function as a means to send electric current through the pest.

2. Description of the Prior Art

Devices have been disclosed in the prior art that relate to pet grooming and tick removal devices. These include devices that have been patented and published in patent application publications, and generally are limited to tweezers and combs that function as either a tick removal tool or for a means to remove loose hair from a pet. The forgoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,074,006 to Eremita discloses a pet vacuum comb that is designed to utilized a powered vacuum device to remove fleas, ticks, loose hair and debris from a pet when combed thereover. The device comprises a housing having a fontal opening shrouded by tines and a rear collecting compartment for capturing the withdrawn debris from the pet's body. A motor-driven fan blade produces the vacuum for drawing in debris, while a handle grip having an internal tube provides a means to draw in ambient air for cooling the operating motor during operation. The Eremita device, while providing a means to remove fleas and debris from a pet, utilizes a pneumatic suction process that draws in dirt, debris and insects from the pet's body, as opposed to an electrical flea terminating process as provided in the present invention.

U.S. Pat. No. 5,374,274 to Sproviero discloses a method and apparatus for extracting a tick from the flesh of a victim using a pair of insulated jaws that form tweezers to grasp the body of the tick. A pulsed electric current is passed through the tweezer jaws and into a grasped tick, shocking the tick and loosening its grip on the victim and facilitating complete removal of the pest. A piezoelectric controller provides a means to modulate the current through the tick, wherein the user controls the tweezers with one hand and the electrical controller with another. The device is provided as a tick tweezer removal device for manual extraction of the tick during the process. The present invention relates to combing device that combines electrical currents to shock ticks within the pet's hair. The structure and intent of the present invention differ, where the Sproviero device deals with imbedded ticks that have buried into the flesh of the victim.

Similar to the Sproviero device, U.S. Pat. No. 6,179,847 to Possum discloses a tick removal device for visually locating a tick imbedded on a host and providing a means to remove the tick intact from the host without pain to the host during the removal process. The device comprises an elongated handle having a first and second tweezer tips that form positive and negative electrodes, along with a light source shining between the tweezer tips and onto the host surface. A battery within the body of the device provides power, as the user grips the tick with one hand on the device while in the “ON” position. Gripping the tick sends current through the tick and allows it to release its grip, ensuring complete removal without remnants or partial tick structures left in the host's skin surface. The Possum device, while contemplating the use of electrical current as a means to shock and loosen a tick from a host, does not provide a comb structure, and is further directed to a tick removal device after the tick has imbedded itself into the host's skin. The present invention is directed to a comb having electrodes that both remove debris and send an electric current through any loose pests in the host's hair.

The present invention diverges from those devices in the prior art by providing a means to kill insects and other pests that are positioned in the hair of a pet, prior to their attachment to the pet's skin surface. The device provides an electrified comb for both hygiene and pest removal purposes. It substantially that the present invention diverges in design elements and intent from the prior art, and consequently it is clear that there is a need in the art for an improvement to existing grooming and pest eliminating devices. In this regard the instant invention substantially fulfills these needs.

### SUMMARY OF THE INVENTION

In view of the foregoing disadvantages inherent in the known types of grooming and pest eliminating devices now present in the prior art, the present invention provides a new electrified comb device that can be utilized for providing convenience for the user when grooming and removing tick, fleas and other pests from the hair of a pet.

It is therefore an object of the present invention to provide a new and improved grooming and pest eliminating device that has all of the advantages of the prior art and none of the disadvantages.

It is another object of the present invention to provide a grooming and pest eliminating device that includes a means of removing loose hair and further killing non-imbedded insects and pests from a pet.

Another object of the present invention is to provide a grooming and pest eliminating device that includes a comb working end and a handle gripping end, wherein the comb includes electrodes for shocking and killing pet pests and the handle controls the operation of the electrical current.

Yet another object of the present invention is to provide a grooming and pest eliminating device that is compact, easy to handle and one that requires battery power to function.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention, including an exploded view of the power source and a close-up view of the comb teeth electrodes.

FIG. 2 shows a close-up view of the comb teeth electrodes of the present invention in a working state.

FIG. 3 shows a pictorial example of the present invention in a working state, wherein a pet is being groomed and pests within the pet's hair are being eliminated.

### DETAILED DESCRIPTION OF THE INVENTION

Reference is made herein to the attached drawings. Like reference numerals are used throughout the drawings to depict like or similar elements of the pet grooming and pest eliminating device. For the purposes of presenting a brief and clear description of the present invention, the preferred embodiment will be discussed as used for combing a pet's coat and further for killing non-imbedded pets within the pet's hair using a handheld comb device. The figures are intended for representative purposes only and should not be considered to be limiting in any respect.

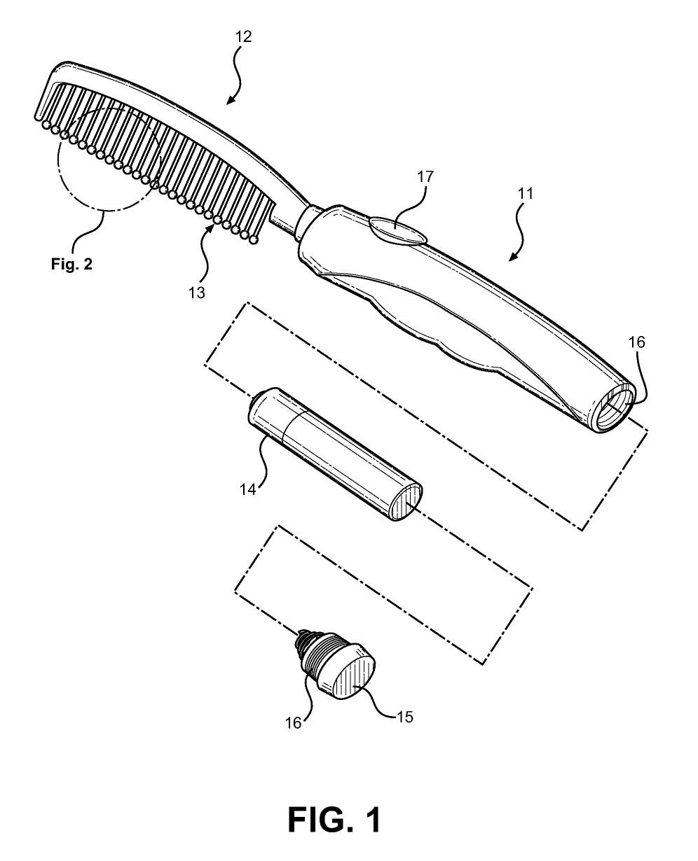

Referring now to FIG. 1, there is shown a perspective view of the electrified grooming device of the present invention. The device is a handheld comb device that comprises a handle proximal end 11 attaching to a comb working end 12. Within the handle 11 there is an open cavity for placement of a battery power source 14, necessary electrical connections for drawing current from the battery 14 to the comb working end 12 and to the comb teeth 13 thereon. Along with a one hand user grip, the handle 11 provides an operational switch 17, which controls the flow of current to the comb working end 12 from the battery power supply. The teeth 13 themselves are aligned in parallel along the length of the comb, as is provided in traditional hair combs in the art. Each successive tooth includes a polarity based on its electrical connection, wherein each adjacent comb tooth 18 is of opposite polarity 20. Those having positive polarity are connected to the positive battery terminal 14, while the negative polarity teeth include connector leads that are routed to the negative terminal of the battery 14. In this way, each comb tooth 18 acts as a switch, wherein a tick, flea or other discrete pest acts as a bridge between two teeth 18 of opposing polarity to close the switch and send current therethrough. This allows current to flow from the battery to the positive polarity tooth, through the pest and to the negative terminal tooth, killing the pest in the process.

Along the base of each comb tooth 18 is a electrical insulator 19 that prevents contact with the pet's skin surface and therefore prevents arcs of current to conduct through the pet's skin, which would otherwise act as a medium and shock the pet in the process. It is desired to disclose an electrical device that is operable on loosely positioned pests or pests within the fur of a pet prior to their imbedding into the pet's skin. It is further desired to provide such a tool that does not cause undue harm or discomfort to the animal in process, but rather targets ticks, fleas and other insects for the purposes of killing them prior to their causing further harm to the pet. The battery power supply 14 is replaceable within the handle, wherein an end cap 15 is threadably attached 16 thereto for securement.

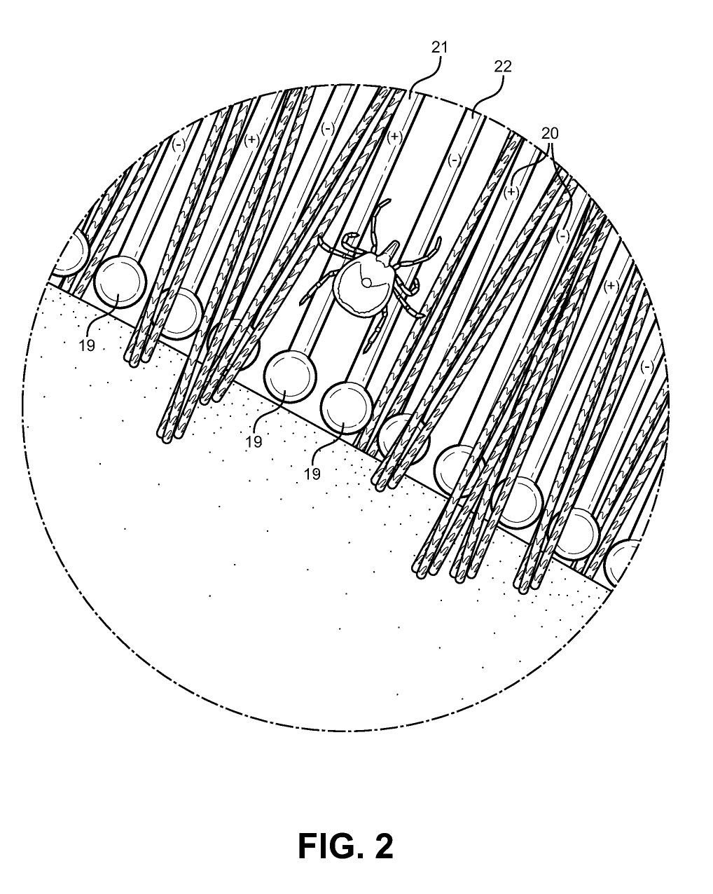

Referring now to FIG. 2, there is shown a close-up view of the comb being utilized to brush a pet's hair and remove pests nestled within the hair but unattached from the pet's skin surface. During operation, the comb working end is drawn over the fur or hair of the pet in a fashion familiar to hair combing, wherein the comb insulator tips are pressed against the pet's skin surface 19 or just thereabove while the comb is drawn along the length of the pet's body. This removes loose hair and dander and also allows the electrode comb teeth 18 to contact any foreign debris or pests within the hair. The polarization 20 of adjacent comb teeth are opposite, allowing any contacted tick, flee or insect to act as the bridge therebetween, drawing current through its body from the positive tooth 21 to the negative tooth. The current is sufficient to kill the insect and prevent further breeding or burrowing into the pet's skin surface, even if the insect is not realized and not completely removed in the combing operation. The insulator tips 19 serve as a means to protect the pet from shock and further provide a soothing contact between the comb ends and the skin surface of the pet while being groomed. The aligned row of comb teeth 18 is the preferred embodiment of the present invention, which provides a structure similar to a planar hair comb. In an alternate embodiment, a comb having a plurality of adjacent comb teeth is provided into a three dimensional space, wherein adjacent teeth remain oppositely charge or having opposite electrical polarity. It is not desired to limit the present invention to a structure having a singular alignment of comb teeth, but rather to disclose a grooming and pest killing device using electrical comb teeth and a power supply.

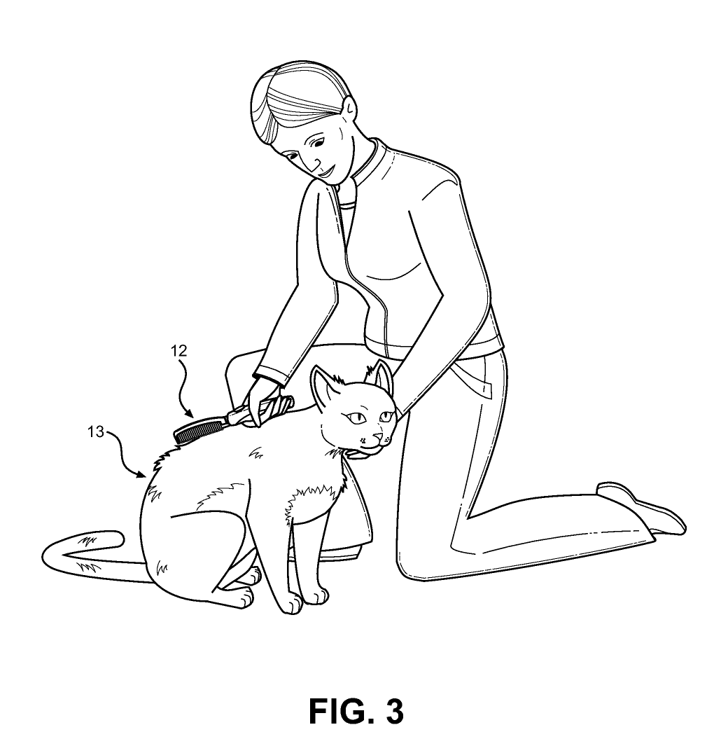

Referring now to FIG. 3, there is shown a pictorial example of the present invention in a working state, wherein a pet owner is utilizing the comb working end 12 to brush the fur of her animal 31 and further to ensure the animal's fur is free of living insects, pests or parasitic insects that may be hiding therein. This activity both removes loose hair and grooms the pet, it also reduces the likelihood of the pet from developing diseases commonly carried by pet pests and prevents pain inflicted from parasitic borrowing of a tick or similar pest into the pet's skin. This activity can be conducted over regular intervals, and further may be conducted after the pet has been outdoors for a given period, wherein such an environment is conducive for gathering ticks, fleas and the like.

It can be difficult for pet owners to control ticks and fleas that are attracted to the pets and lodge themselves into the pet's hair. If cats or dogs develop a tick or flea problem, they may experience pain, side effects of the infestation, discomfort and superficial itching. Itching of this sort leads to chronic scratching, which can lead to open, infected areas and patches of skin that can get larger and more serious if left untreated. Additionally, if one animal has a flea or tick problem, the problem may quickly spread to other pets in the household and exacerbate the problem. These pests may further transfer to their owners, causing health concerns for owners, their families and their homes. Ticks, in particular, can carry and transmit diseases such as Lyme's disease to both humans and animals, which is considerable health hazard and risk that must be mitigated through reduced exposure.

To rid animals of these pests, some owners use a chemical treatment; however these treatments can be harsh or damaging to the coat of the pet. The present invention provides a comb grooming tool that includes a means to conducting current through trapped fleas and ticks that contact the comb when grooming pets such as cats and dogs. The device resembles a toothed comb with a handle, wherein the handle includes electrical power and user control, while the combed working end provides comb tooth electrodes that conduct the current through the pest without endangering or hurting the pet. Pet owners can use the comb to brush their dog's or cat's fur, and when turned on, the comb can produce small electrical charges that can emit through its teeth to electrocute and kill fleas, ticks and other discrete pets. It is contemplated that the device would find regular use in pet owner households, pet groomer establishments, or pet caretaker kennels.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) Pet grooming and pest terminating device, comprising:
a proximal handle end and a comb working end;
said proximal handle end having an internal cavity for a placement of a power source, a user grip and an operational switch;
said comb working end comprising a plurality of elongated comb teeth, said teeth having an inherent electrical polarity and an electrically insulated termination;
said teeth being spaced apart from one another and aligned such that adjacent teeth comprise opposite polarity;
electrical connections from said power source to said comb teeth, wherein an article bridging said teeth spacing draws current from said battery and through said article.

2) The device of claim 1, wherein said comb working end further comprises a singular alignment of comb teeth having alternating electrical polarity.

3) The device of claim 1, wherein said comb working end further comprises a plurality of adjacent comb teeth consuming a three dimensional space, said adjacent teeth having opposite electrical polarity and being closely spaced.

4) The device of claim 1, wherein each of said comb teeth comprise a positive or negative electrical polarity, current flowing from a battery positive terminal into a positive polarity tooth, across said bridging article, into an adjacent negative polarity tooth and to said battery negative terminal.

5) The device of claim 1, wherein said bridging article is a pet pest, and said battery current is sufficient for killing said pest upon contact with said comb teeth.
